(19) United States
(12) Patent Application Publication
(10) Pub. No.: US 2025/0293378 A1
(43) Pub. Date: Sep. 18, 2025

(54) POWER STORAGE DEVICE AND VEHICLE

(71) Applicants: TOYOTA JIDOSHA KABUSHIKI KAISHA, Aichi-ken (JP); TOYOTA BATTERY CO., LTD., Shizuoka (JP)

(72) Inventors: Kazuhito KATO, Toyota-shi (JP); Yoshiro OBAYASHI, Toyota-shi (JP); Yosuke SHIMURA, Nagakute-shi (JP); Kenta MIYAHARA, Toyohashi-shi (JP); Takuya NOGUCHI, Toyota-shi (JP); Ryutaro SUZUKI, Hamamatsu-shi (JP); Yuji KATAYAMA, Okazaki-shi (JP); Masaya OGURA, Hamamatsu-shi (JP)

(21) Appl. No.: 19/057,976

(22) Filed: Feb. 20, 2025

(30) Foreign Application Priority Data
Mar. 13, 2024 (JP) 2024-039268

(51) Int. Cl. H01M 50/264; H01M 10/6554; H01M 50/204; H01M 50/249; H01M 50/367

(52) U.S. Cl. CPC H01M 50/264; H01M 10/6554; H01M 50/204; H01M 50/249; H01M 50/367; H01M 2220/20

(57) ABSTRACT

A power storage device includes a casing and a cell connected body accommodated in the casing. The cell connected body includes a plurality of power storage cells and a connection portion that electrically connects the power storage cells to each other. The power storage device further includes a holding member that holds at least one power storage cell, between an inner surface of the casing and the cell connected body.

### CROSS REFERENCE TO RELATED APPLICATIONS

This nonprovisional application is based on Japanese Patent Application No. 2024-039268 filed with the Japan Patent Office on Mar. 13, 2024, the entire contents of which are hereby incorporated by reference.

### BACKGROUND

### Field

The present disclosure relates to a power storage device and a vehicle including the power storage device.

### Description of the Background Art

Japanese National Patent Publication No. 2023-502457 discloses a battery (power storage device) in a shape of a parallelepiped having a length L from 400 mm to 2500 mm and having a ratio (L/H) of length L to a width H of 4 to 21.

### SUMMARY

In the power storage device described in Japanese National Patent Publication No. 2023-502457, a plurality of electrode core sets aligned in a line as being connected in series are arranged in a casing (housing). In this power storage device, an electrode core set corresponds to a power storage cell. A connected body where a plurality of power storage cells are connected in a line is referred to as a “cell connected body” below.

In the power storage device described in Japanese National Patent Publication No. 2023-502457, excessive movement of cell connected bodies in the casing tends to cause damage to a portion of connection between power storage cells or the like.

The present disclosure was made to solve the problem above, and an object thereof is to improve durability of a power storage device including a cell connected body.

According to a form according to a first point of view of the present disclosure, a power storage device shown below is provided.

(Clause 1) A power storage device includes a casing and a cell connected body accommodated in the casing. The cell connected body includes a plurality of power storage cells and a connection portion that electrically connects the power storage cells to each other. The power storage device further includes one or more holding members that hold at least one of the plurality of power storage cells, between an inner surface of the casing and the cell connected body.

In the construction, at least one of the plurality of power storage cells included in the cell connected body is held by the holding member so that the cell connected body is less likely to move. A portion of connection between the power storage cells or the like is thus less likely to be damaged. According to the construction, durability of the power storage device against external impact or the like is improved. The connection portion may be formed from a conductive member. The connection portion may connect electrodes of adjacent power storage cells to each other to electrically connect those power storage cells to each other. A positive electrode of one of two adjacent power storage cells and a negative electrode of the other power storage cell may be connected to each other by the connection portion.

(Clause 2) In the power storage device described in Clause 1, the one or more holding members include a first holding member that is formed along the cell connected body to hold a first surface of each of the plurality of power storage cells.

As one holding member (first holding member) holds the first surface of each power storage cell included in the cell connected body as above, the cell connected body can appropriately be held while the number of components is reduced.

(Clause 3) In the power storage device described in Clause 2, a first main body portion in a shape of a plate and one or more first projections that project from the first main body portion toward the cell connected body are included.

According to the first holding member constructed as above, the first projection more readily restricts movement of the cell connected body.

(Clause 4) In the power storage device described in Clause 2 or 3, the one or more holding members further include a second holding member that is formed along the cell connected body to hold a second surface opposite to the first surface of each of the plurality of power storage cells.

As the second holding member holds the second surface of each power storage cell included in the cell connected body, the first holding member and the second holding member can clamp each power storage cell included in the cell connected body. According to such a construction, the cell connected body is more readily properly held.

(Clause 5) In the power storage device described in Clause 4, the second holding member includes a second main body portion in a shape of a plate and one or more second projections that project from the second main body portion toward the cell connected body.

According to the second holding member constructed as above, the second projection more readily restricts movement of the cell connected body.

(Clause 6) In the power storage device described in any one of Clauses 2 to 5, a flow path is provided in at least one of the first holding member and the second holding member. The flow path is configured to discharge gas generated from at least one of the plurality of power storage cells.

According to the construction, gas generated from the power storage cell is more readily appropriately emitted.

(Clause 7) In the power storage device described in any one of Clauses 2 to 6, at least one of the first holding member and the second holding member has a hollow structure.

As a cavity is provided in at least one of the first holding member and the second holding member as above, impact externally applied to the casing is more readily absorbed by the at least one of the first holding member and the second holding member.

(Clause 8) In the power storage device described in any one of Clauses 4 to 7, the second holding member is higher in thermal conductivity than the first holding member.

In the power storage device, the second holding member located on a side of the second surface of the power storage cell is high in thermal conductivity. Therefore, the power storage cell is more readily heated or cooled from the side of the second surface of the power storage cell.

(Clause 9) In the power storage device described in Clause 8, the second holding member contains metal and the first holding member contains resin.

As the second holding member contains metal as above, thermal conductivity of the second holding member is high. The first holding member containing resin, on the other hand, is excellent in toughness and formability, and hence it readily holds each power storage cell included in the cell connected body.

(Clause 10) In the power storage device described in any one of Clauses 4 to 9, a tapered surface is formed at an end of each of the first holding member and the second holding member.

As the tapered surface is formed at the end of each holding member as above, the cell connected body to which the first holding member and the second holding member are attached is more readily inserted in the casing.

(Clause 11) In the power storage device described in any one of Clauses 4 to 10, the cell connected body, the first holding member, and the second holding member are integrated by winding a member in a form of a line, a band, or a sheet.

As the cell connected body, the first holding member, and the second holding member are integrated as above, position displacement is less likely.

(Clause 12) In the power storage device described in any one of Clauses 1 to 11, the casing has a geometry in a shape of a parallelepiped. The casing is provided with four surfaces that extend in a connection direction of the cell connected body and two surfaces that cover ends of the cell connected body. The four surfaces include first opposing surfaces which are a pair of surfaces opposed to each other and second opposing surfaces which are opposing surfaces larger in area than the first opposing surfaces. The holding members are arranged on the first opposing surfaces.

As the holding members are arranged on the opposing surfaces small in area (a pair of opposing surfaces) as above, a dimension of the holding members that hold the power storage cells can more readily be made smaller.

According to a form according to a second point of view of the present disclosure, a vehicle shown below is provided.

(Clause 13) The vehicle includes the power storage device according to any one of Clauses 1 to 12.

In connection with the vehicle, durability of the power storage device including the cell connected body is improved.

The foregoing and other objects, features, aspects, and advantages of this disclosure will become more apparent from the following detailed description of this disclosure when taken in conjunction with the accompanying drawings.

### BRIEF DESCRIPTION OF THE DRAWINGS

FIG. 1 is a diagram for illustrating a construction of a power storage device according to an embodiment of the present disclosure.

FIG. 2 is a perspective view showing as being enlarged, inside of a casing of the power storage device shown in FIG. 1.

FIG. 3 is a diagram for illustrating a construction of each cell connected body shown in FIG. 1.

FIG. 4 is an exploded perspective view of the power storage cell included in each cell connected body shown in FIG. 1.

FIG. 5 is a cross-sectional view along the line V-V in FIG. 1.

FIG. 6 is a cross-sectional view along the line VI-VI in FIG. 1.

FIG. 7 is a diagram showing a first modification of the power storage device shown in FIG. 1.

FIG. 8 is a cross-sectional view corresponding to FIG. 5, of a power storage device according to a first modification.

FIG. 9 is a cross-sectional view corresponding to FIG. 6, of the power storage device according to the first modification.

FIG. 10 is a diagram showing a second modification of the power storage device shown in FIG. 1.

FIG. 11 is a diagram showing a third modification of the power storage device shown in FIG. 1.

FIG. 12 is a diagram showing a fourth modification of the power storage device shown in FIG. 1.

FIG. 13 is a diagram showing a fifth modification of the power storage device shown in FIG. 1.

FIG. 14 is a diagram showing a sixth modification of the power storage device shown in FIG. 1.

FIG. 15 is a diagram showing a seventh modification of the power storage device shown in FIG. 1.

FIG. 16 is a diagram showing an eighth modification of the power storage device shown in FIG. 1.

FIG. 17 is a diagram showing a ninth modification of the power storage device shown in FIG. 1.

FIG. 18 is a diagram showing a tenth modification of the power storage device shown in FIG. 1.

FIG. 19 is a diagram showing an eleventh modification of the power storage device shown in FIG. 1.

FIG. 20 is a diagram showing a twelfth modification of the power storage device shown in FIG. 1.

FIG. 21 is a cross-sectional view along the line XXI-XXI in FIG. 20.

FIG. 22 is a diagram showing an exemplary power storage module including a plurality of batteries.

FIG. 23 is a diagram showing an exemplary vehicle on which the power storage module shown in FIG. 22 is mounted.

### DESCRIPTION OF THE PREFERRED EMBODIMENTS

An embodiment of the present disclosure will be described in detail with reference to the drawings. The same or corresponding elements in the drawings have the same reference characters allotted and description thereof will not be repeated. In each figure referred to below, among an X axis, a Y axis, and a Z axis orthogonal to one another, the X axis represents a first in-plane direction (for example, a length direction) of a battery, the Y axis represents a second in-plane direction (for example, a width direction) of the battery, and the Z axis represents a height direction of the battery. A direction indicated by an arrow along each of the X axis, the Y axis, and the Z axis is expressed with “+” below, and a direction opposite thereto is expressed with “−”.

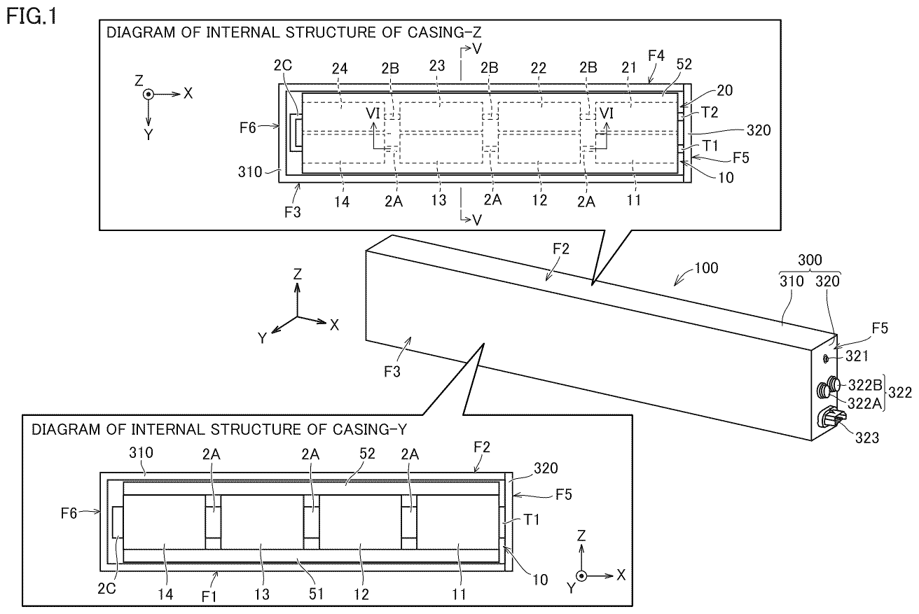

FIG. 1 is a diagram for illustrating a construction of a power storage device according to this embodiment. A “diagram of internal structure of casing−Z” in FIG. 1 is a diagram of components in the casing viewed from a +Z side. A “diagram of internal structure of casing−Y” is a diagram of components in the casing viewed from a +Y side.

The power storage device according to this embodiment is a battery 100 shown in FIG. 1. Battery 100 is a secondary battery such as a lithium ion battery, a nickel metal hydride battery, or a sodium ion battery. An exemplary lithium ion battery includes an LFP battery in which lithium iron phosphate is adopted as a positive electrode active material or a ternary battery in which nickel manganese cobalt (NMC) is adopted as the positive electrode active material. A type of the secondary battery may be a liquid secondary battery or an all-solid secondary battery. Though details will be described later, battery 100 includes a plurality of power storage cells each of which functions as the secondary battery. Battery 100 may include only power storage cells of the same type (for example, only LFP batteries) or power storage cells different in type (for example, the LFP battery and the ternary battery).

Battery 100 includes a casing 300. Casing 300 has a geometry in a shape of a parallelepiped. Casing 300 is provided with a pair of surfaces F1 and F2 (first opposing surfaces) opposed to each other in a Z direction, a pair of surfaces F3 and F4 (second opposing surfaces) opposed to each other in a Y direction, and surfaces F5 and F6 located at respective ends in an X direction (end surfaces in the X direction). Each of surfaces F1 and F2 is smaller in area than each of surfaces F3 and F4. A length (a dimension in the X direction) of casing 300 is longer than a width (a dimension in the Y direction) of casing 300. The length of casing 300 may be not smaller than 250 mm and not larger than 5000 mm, and it is, for example, approximately 1000 mm. The width of casing 300 may be not smaller than 10 mm and not larger than 1250 mm, and it is, for example, approximately 50 mm. A ratio of the length of casing 300 to the width of casing 300 may be not lower than 4 and not higher than 25. A height (a dimension in the Z direction) of casing 300 may be not smaller than 10 mm and not larger than 1250 mm, and it is, for example, approximately 100 mm. The dimension of casing 300 is not limited as above.

Casing 300 includes a main body 310 and a lid body 320. Main body 310 is a hollow housing with bottom, for example, provided with an opening in an end surface on a +X side, and cell connected bodies 10 and 20 are accommodated therein. Lid body 320 is a plate-shaped member (cover member) with a geometry corresponding to the opening in main body 310, and closes the opening on the +X side in main body 310. Main body 310 and lid body 320 may be formed of the same material or different materials. For example, metal can be adopted as the material for each of main body 310 and lid body 320. Casing 300 may be a casing made of aluminum. These materials can be changed as appropriate. For example, lid body 320 may be formed of an insulating material.

Cell connected body 10 includes four power storage cells 11 to 14 and three connection portions 2A that electrically connect the power storage cells to one another. Power storage cells 11 to 14 are connected in a line in the X direction in casing 300. Cell connected body 20 includes four power storage cells 21 to 24 and three connection portions 2B that electrically connect the power storage cells to one another. Power storage cells 21 to 24 are connected in a line in the X direction in casing 300. Cell connected body 10 and cell connected body 20 are thus arranged in parallel to the X direction. Each of surfaces F1 to F4 of casing 300 extends in a connection direction (X direction) of cell connected bodies 10 and 20. Each of surfaces F5 and F6 of casing 300 covers an end in the X direction of cell connected bodies 10 and 20. Each power storage device included in cell connected bodies 10 and 20 is configured to store electric power.

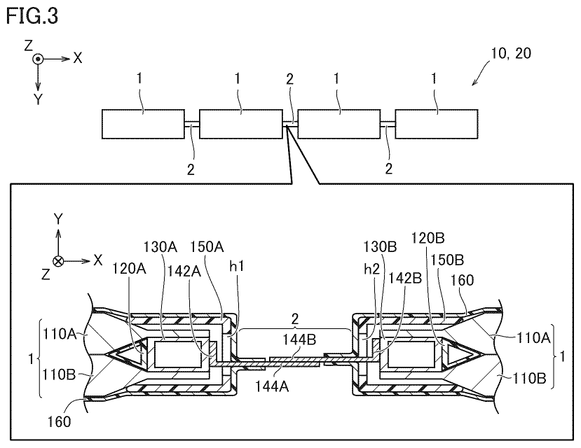

In casing 300 of battery 100, cell connected body 10 and cell connected body 20 are electrically connected to each other. Specifically, as shown in FIG. 1, an end (power storage cell 14) on an −X side of cell connected body 10 and an end (power storage cell 24) on the −X side of cell connected body 20 are electrically connected to each other, for example, through a U-shaped connection portion 2C in casing 300. Connection portion 2C has a cross-section in a U shape, whereas each of connection portions 2A and 2B has a cross-section in an I shape. Connection portion 2C is basically similar in structure to connection portion 2A or 2B except that it is formed in a different shape. Connection portion 2C may be an integrally formed article or a composite of a plurality of separately formed components. For example, connection portion 2C may be formed from connection through a conductive material (beam portion), of a protruding portion 144B (FIG. 3) that protrudes from power storage cell 14 and a protruding portion 144B (FIG. 3) that protrudes from power storage cell 24 to each other. Protruding portion 144B will be described later.

Cell connected bodies 10 and 20 are arranged such that positions of the power storage cells are aligned and positions of the connection portions are aligned. Power storage cells 11, 12, 13, and 14 included in cell connected body 10 are superimposed on power storage cells 21, 22, 23, and 24 included in cell connected body 20 in the Y direction, respectively. In other words, all power storage cells included in cell connected body 10 are arranged as being opposed in the Y direction to any power storage cells included in cell connected body 20, respectively. An end surface on a −Z side of each power storage cell may be referred to as a “first surface” below and an end surface on the +Z side (the end surface opposite to the first surface) of each power storage cell may be referred to as a “second surface” below.

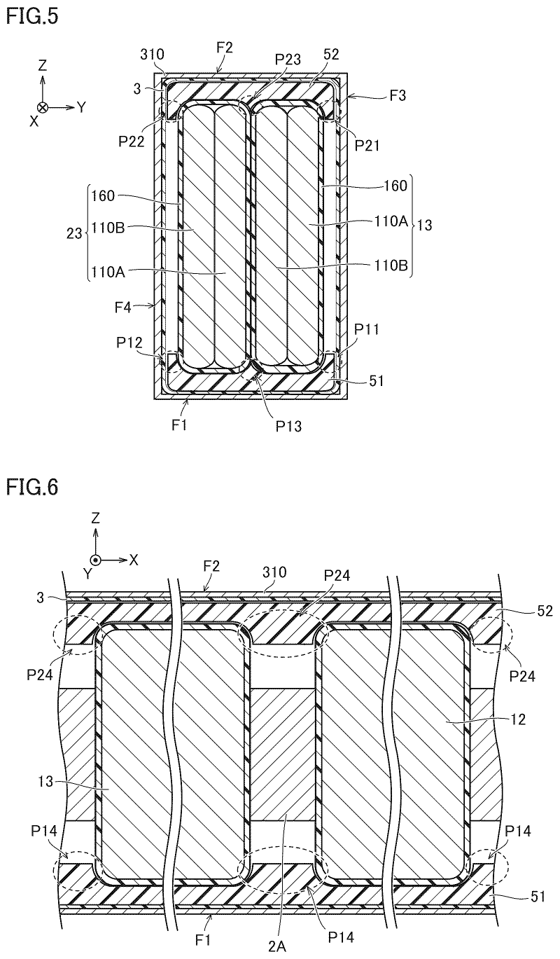

Holding members 51 and 52 are further accommodated in casing 300. Holding members 51 and 52 are located between an inner surface of casing 300 (more specifically, an inner surface of main body 310) and respective cell connected bodies 10 and 20. Each of cell connected bodies 10 and 20 is formed in parallel to the X direction. Holding members 51 and 52 are formed along cell connected bodies 10 and 20 and formed as being elongated in the X direction. Holding member 51 holds the first surface of each of power storage cells 11 to 14 included in cell connected body 10 and the first surface of each of power storage cells 21 to 24 included in cell connected body 20. Holding member 52 holds the second surface of each of power storage cells 11 to 14 included in cell connected body 10 and the second surface of each of power storage cells 21 to 24 included in cell connected body 20. Cell connected bodies 10 and 20 are clamped by holding members 51 and 52. According to holding members 51 and 52, cell connected bodies 10 and 20 can appropriately be held while the number of components is reduced. Holding member 51 and holding member 52 correspond to an exemplary “first holding member” and an exemplary “second holding member” according to the present disclosure, respectively. Details of holding members 51 and 52 will be described later (see FIGS. 5 and 6).

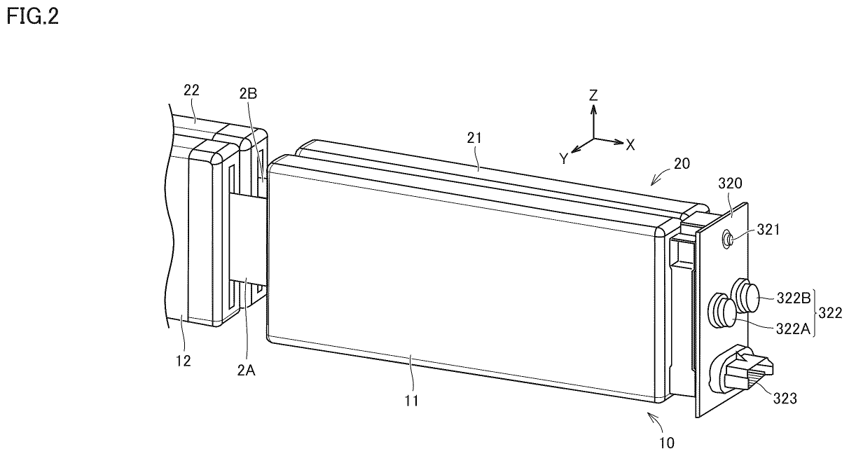

An end (power storage cell 11) on the +X side of cell connected body 10 is connected to lid body 320 with a connection terminal T1 being interposed. An end (power storage cell 21) on the +X side of cell connected body 20 is connected to lid body 320 with a connection terminal T2 being interposed. FIG. 2 is a perspective view showing as being enlarged, the ends on the +X side of cell connected bodies 10 and 20 with holding members 51 and 52 having been removed.

Lid body 320 includes a sealing hole 321, an external terminal 322, and a connector 323. Sealing hole 321 may be a pressure regulation hole for regulation of a pressure in casing 300. Sealing hole 321 has a sealing structure, for example, with a metallic cap (outside of the casing) and a sealing member (inside of the casing). While such a sealing structure ensures hermeticity in casing 300, gas is emitted to the outside of casing 300 through sealing hole 321 when the pressure in casing 300 exceeds a prescribed level. External terminal 322 includes an electrode tab 322A joined (for example, welded with laser) to connection terminal T1 (FIG. 1) of cell connected body 10 and an electrode tab 322B joined (for example, welded with laser) to connection terminal T2 (FIG. 1) of cell connected body 20. Electrode tabs 322A and 322B are electrically connected to power storage cells 11 and 21, respectively. Each of electrode tabs 322A and 322B may be provided with an insulating sealing structure composed of ceramics, for example, around an electrode. In this embodiment, electrode tabs 322A and 322B function as a negative electrode tab and a positive electrode tab, respectively. Without being limited as such, with polarity being reversed, electrode tab 322B may serve as the negative electrode tab and electrode tab 322A may serve as the positive electrode tab. Connector 323 includes, for example, an output terminal that outputs a detection signal indicating a state (for example, a temperature of each power storage cell) in casing 300 detected by one or more sensors in casing 300 to the outside of the casing and an input terminal that receives input of a control signal from the outside of the casing to one or more devices in casing 300. For example, a temperature sensor may be provided for each power storage cell in casing 300.

Cell connected bodies 10 and 20 are inserted in main body 310 with holding members 51 and 52 being attached thereto. As the power storage cells are held by holding members 51 and 52, insertion of cell connected bodies 10 and 20 in main body 310 is facilitated. Holding members 51 and 52 may be attached before or after welding of connection portions 2A and 2B (for example, welding of protruding portions 144A and 144B which will be described later). After cell connected bodies 10 and 20 are inserted in main body 310 together with holding members 51 and 52, main body 310 and lid body 320 are joined to each other. Main body 310 and lid body 320 are welded, for example, with laser.

In this embodiment, cell connected body 10 and cell connected body 20 are basically identical to each other in construction. Therefore, when power storage cells 11 to 14 and 21 to 24 are not distinguished, they are referred to as a “power storage cell 1” below, and when connection portions 2A and 2B are not distinguished, they are referred to as a “connection portion 2” below.

FIG. 3 is a diagram for illustrating a construction of each of cell connected bodies 10 and 20. As shown in FIG. 3, each cell connected body includes four power storage cells 1. Connection portion 2 is provided between adjacent power storage cells 1 and connection portion 2 electrically connects those power storage cells 1 to each other. Each cell connected body is constructed of power storage cells 1 and connection portions 2 that are alternately aligned. In each of cell connected bodies 10 and 20, power storage cells 1 are connected to each other through connection portion 2. Connection portion 2 is lower in rigidity than power storage cell 1. Power storage cells 11 to 14 and 21 to 24 are formed from identical power storage cells 1. By forming cell connected bodies 10 and 20 from common power storage cells 1, manufacturing of battery 100 is facilitated and manufacturing cost can be reduced.

The construction of cell connected bodies 10 and 20 is not limited to the construction above. Each cell connected body may include power storage cells different in dimension or may include power storage cells different in shape. The number of power storage cells to be accommodated in casing 300 is not limited to eight but can be varied as appropriate. The number of power storage cells included in each cell connected body may be smaller than four, may be not smaller than five and not larger than nineteen, or may be equal to or larger than twenty.

In this embodiment, power storage cell 1 is a laminated cell including one or more wound bodies. In the laminated cell, one or more wound bodies that function as an electrode assembly are covered with a laminated exterior body. FIG. 2 shows the power storage cell without the laminated exterior body. The wound body has a structure, for example, in which a positive electrode sheet and a negative electrode sheet are wound with a separator lying therebetween. Each of the positive electrode sheet and the negative electrode sheet contains an electrode foil and an active material layer.

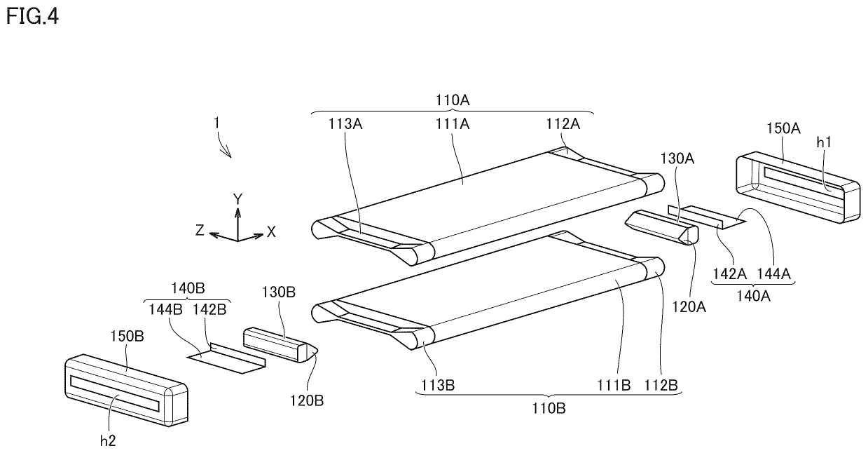

FIG. 4 is an exploded perspective view of power storage cell 1. A structure of power storage cell 1 and connection portion 2 will be described below with reference to the cross-sectional view in FIG. 3 (an X-Y cross-sectional view around connection portion 2) and FIG. 4.

As shown in FIG. 4, power storage cell 1 includes two wound bodies 110A and 110B, spacers 120A and 120B, terminal members 130A and 130B, and covers 150A and 150B.

Wound body 110A includes a coated portion 111A, an electrode tab 112A, and an electrode tab 113A. Wound body 110B includes a coated portion 111B, an electrode tab 112B, and an electrode tab 113B. Each of coated portions 111A and 111B is an area in the positive electrode sheet or the negative electrode sheet where the active material layer is provided in the electrode foil. Each of electrode tabs 112A, 112B, 113A, and 113B is an area in the positive electrode sheet or the negative electrode sheet where the electrode foil is exposed (an uncoated portion where the active material layer is not provided). Electrode tabs 112A and 112B are located at ends on the +X side of wound bodies 110A and 110B, respectively. Electrode tabs 113A and 113B are located at ends on the −X side of wound bodies 110A and 110B, respectively.

Electrode tab 112A and electrode tab 112B are arranged as being superimposed in the Y direction, and spacer 120A and terminal member 130A are provided between electrode tab 112A and electrode tab 112B (see FIG. 3). Electrode tab 113A and electrode tab 113B are arranged as being superimposed in the Y direction, and spacer 120B and terminal member 130B are provided between electrode tab 113A and electrode tab 113B (see FIG. 3).

Each of spacers 120A and 120B contains an insulating material (for example, synthetic resin) and it is insulating. Spacers 120A and 120B are each in a shape increasing in dimension in the Y direction as they are more distant from coated portions 111A and 111B (see FIG. 3). Terminal member 130A is connected to an end surface on the +X side of spacer 120A. Terminal member 130B is connected to an end surface on the −X side of spacer 120B. Each of terminal members 130A and 130B contains a conductive material (for example, metal such as aluminum or copper) and it is conductive. Wound body 110A and wound body 110B are joined to each other (for example, welded with laser) with terminal members 130A and 130B being interposed.

Each of current collection terminals 140A and 140B is a component that forms a part of connection portion 2. Current collection terminal 140A includes a support portion 142A and protruding portion 144A. Current collection terminal 140B includes a support portion 142B and protruding portion 144B. One of current collection terminals 140A and 140B functions as a positive electrode current collection terminal and the other thereof functions as a negative electrode current collection terminal. In one example, the positive electrode current collection terminal is formed of aluminum and the negative electrode current collection terminal is formed of copper.

Each of current collection terminals 140A and 140B is formed in an L shape. Each of support portions 142A and 142B is formed in a shape of a plate on a Y-Z plane and each of protruding portions 144A and 144B is formed in a shape of a plate on an X-Z plane. Support portion 142A and protruding portion 144A may be formed separately from each other and then joined to each other, or formed as being integrated by bending. Support portion 142B and protruding portion 144B may also be formed separately from each other and then joined to each other, or formed as being integrated by bending. Support portion 142A is joined (for example, welded with laser) to an end surface on the +X side of terminal member 130A (see FIG. 3). Support portion 142B is joined (for example, welded with laser) to an end surface on the −X side of terminal member 130B (see FIG. 3).

Cover 150A covers the end (including electrode tabs 112A and 112B) on the +X side of power storage cell 1. Cover 150A is provided with a through hole h1 for protruding portion 144A. Protruding portion 144A passes through through hole h1 and protrudes on the +X side of power storage cell 1 (see FIG. 3). Cover 150B covers the end (including electrode tabs 113A and 113B) on the −X side of power storage cell 1. Cover 150B is provided with a through hole h2 for protruding portion 144B. Protruding portion 144B passes through through hole h2 and protrudes on the −X side of power storage cell 1 (see FIG. 3).

As shown in FIG. 3, in connection portion 2, protruding portion 144A of one power storage cell 1 of two adjacent power storage cells 1 is joined (for example, welded with laser) to protruding portion 144B of the other power storage cell 1. A welded portion may be protected by a tape or the like. Though not shown in FIG. 4, a laminated exterior body 160 shown in FIG. 3 is provided on a surface of each of two wound bodies 110A and 110B. Laminated exterior body 160 is, for example, a laminated film and provided on a surface of power storage cell 1.

The construction described above is merely an example of the construction of power storage cell 1 and can be modified as appropriate. For example, the number of wound bodies included in power storage cell 1 is not limited to two, and a single wound body or at least three wound bodies may be provided. A layered body (for example, a layered body in which the positive electrode sheet and the negative electrode sheet are layered with the separator lying therebetween) may be adopted as the electrode assembly, instead of the wound body.

FIG. 5 is a cross-sectional view along the line V-V in FIG. 1. FIG. 6 is a cross-sectional view along the line VI-VI in FIG. 1.

As shown in FIGS. 5 and 6, an insulating layer 3 containing resin such as polyethylene terephthalate (PET) is provided on an inner surface of main body 310 of casing 300. Casing 300 and a component in casing 300 are thus electrically isolated from each other. In the battery where sufficient insulation is ensured, however, insulating layer 3 does not have to be provided. For example, cell connected bodies 10 and 20 and holding members 51 and 52 may be covered with an insulating film (insulating layer). Ease in insertion in casing 300 is improved by integrating these components with the insulating film.

As shown in FIGS. 5 and 6, holding member 51 is basically formed in a shape of a plate. Holding member 51 includes projections P11 to P14 (first projections) that project from the main body portion (first main body portion) in the shape of the plate toward cell connected bodies 10 and 20, in addition to that main body portion. Each of projections P11 to P14 projects toward cell connected bodies 10 and 20 (+Z side). Holding member 52 is basically formed also in the shape of the plate. Holding member 52 includes projections P21 to P24 (second projections) that project from the main body portion in the shape of the plate (second main body portion) toward cell connected bodies 10 and 20, in addition to that main body portion. Each of projections P21 to P24 projects toward cell connected bodies 10 and 20 (−Z side). Each of holding members 51 and 52 contains an insulating material (for example, resin) and it is insulating. Each of holding members 51 and 52 may be an integrally formed article or such a composite that a plurality of separately formed members are joined to one another.

As shown in FIG. 5, projections P11 to P13 are in shapes in conformity with the first surfaces of power storage cells 13 and 23 adjacent in the Y direction and hold ends of the first surfaces to maintain power storage cells 13 and 23 at prescribed positions. Specifically, projections P11 and P12 are located at ends (corner portions) in the Y direction of the first surfaces of power storage cells 13 and 23 and function as tab portions. Projection P11 catches the corner portion of power storage cell 13 and suppresses movement of power storage cell 13 toward the +Y side. Projection P12 catches the corner portion of power storage cell 23 and suppresses movement of power storage cell 23 toward a −Y side. Projection P13 is engaged with a boundary portion between the first surfaces of power storage cells 13 and 23 and suppresses position displacement of power storage cells 13 and 23. Projections P21 to P23 are in shapes in conformity with the second surfaces of power storage cells 13 and 23 adjacent in the Y direction and hold ends of the second surfaces to maintain power storage cells 13 and 23 at prescribed positions. Specifically, projections P21 and P22 are located at ends (corner portions) in the Y direction of the second surfaces of power storage cells 13 and 23 and function as tab portions. Projection P21 catches the corner portion of power storage cell 13 and suppresses movement of power storage cell 13 toward the +Y side. Projection P22 catches the corner portion of power storage cell 23 and suppresses movement of power storage cell 23 toward the −Y side. Projection P23 is engaged with a boundary portion between the second surfaces of power storage cells 13 and 23 and suppresses position displacement of power storage cells 13 and 23.

Though FIG. 5 representatively shows only projections P11 to P13 and P21 to P23 arranged for a pair of power storage cells 13 and 23 adjacent in the Y direction, projections P11 to P13 and P21 to P23 also hold other pairs of power storage cells (a pair of power storage cells 11 and 21, a pair of power storage cells 12 and 22, and a pair of power storage cells 14 and 24) adjacent in the Y direction, with a similar structure.

As shown in FIG. 6, each of projections P14 and P24 is located between power storage cells adjacent in cell connected body 10, similarly to connection portion 2A. Each of projections P14 and P24 has a dimension (a dimension in the X direction) corresponding to an interval between the power storage cells and functions as a spacer. Projection P14 holds the end of the first surface of each of two power storage cells adjacent in cell connected body 10 and serves to set the interval between the adjacent power storage cells constant. Projection P24 holds the end of the second surface of each of two power storage cells adjacent in cell connected body 10 and serves to set the interval between the adjacent power storage cells constant. Each of projections P14 and P24 restricts movement of power storage cell 12 toward the −X side and movement of power storage cell 13 toward the +X side and suppresses power storage cells 12 and 13 coming too close to each other as shown, for example, in FIG. 6.

Though FIG. 6 representatively shows only projections P14 and P24 arranged around a pair of power storage cells 12 and 13, projections P14 and P24 hold other pairs of power storage cells (a pair of power storage cells 11 and 12 and a pair of power storage cells 13 and 14) adjacent in cell connected body 10, with a similar structure. Each of holding members 51 and 52 holds also each pair of power storage cells (a pair of power storage cells 21 and 22, a pair of power storage cells 22 and 23, and a pair of power storage cells 23 and 24) adjacent in cell connected body 20, with projections similar in structure to projections P14 and P24 for cell connected body 10 shown in FIG. 6. Projections P14 and P24 may be arranged between connection portion 2A and connection portion 2B in the Y direction. Projections P14 and P24 arranged as such function as spacers common to cell connected bodies 10 and 20.

In battery 100 according to this embodiment, holding members 51 and 52 are provided between the inner surface of casing 300 and respective cell connected bodies 10 and 20. Power storage cells included in cell connected bodies 10 and 20 are held by holding members 51 and 52. Thus, cell connected bodies 10 and 20 are less likely to move and the portion of connection between the power storage cells or the like is less likely to be damaged. According to such a construction, durability of battery 100 (power storage device) against external impact or the like is improved.

As shown in FIGS. 1, 5, and 6, holding members 51 and 52 are arranged on the first opposing surfaces (surfaces F1 and F2) smaller in area than the second opposing surfaces (surfaces F3 and F4). As holding members 51 and 52 are thus arranged on the opposing surfaces (surfaces F1 and F2) small in area, dimensions of holding members 51 and 52 that hold each power storage cell included in cell connected bodies 10 and 20 are more readily made smaller. Without being limited as such, holding members 51 and 52 may be provided on the second opposing surfaces instead of or in addition to the first opposing surfaces.

Holding members 51 and 52 may be fixed to casing 300 with an adhesive. By not employing the fixing method of this type, however, recyclability of the power storage device tends to be high. In battery 100 (power storage device) according to this embodiment, holding members 51 and 52 hold each power storage cell included in cell connected bodies 10 and 20. Therefore, the adhesive does not have to be used, or adhesiveness of an adhesive to be used can be weak. Recyclability of the power storage device is thus improved. Even when cell connected bodies 10 and 20 move in casing 300 while they are held by holding members 51 and 52, positional relation among the power storage cells is not varied and hence connection portions 2A to 2C are less likely to be damaged.

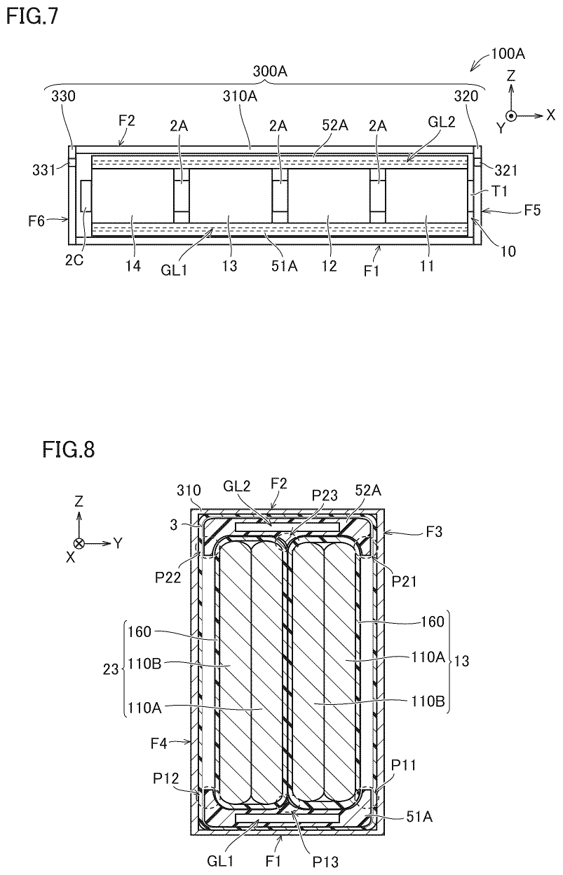

FIG. 7 is a diagram showing a first modification of the battery shown in FIG. 1. FIG. 8 is a cross-sectional view corresponding to FIG. 5, of the battery according to the first modification. FIG. 9 is a cross-sectional view corresponding to FIG. 6, of the battery according to the first modification.

As shown in FIG. 7, a battery 100A according to the first modification is basically similar in construction to battery 100 shown in FIG. 1. Battery 100A includes a casing 300A instead of casing 300 (FIG. 1) and includes holding members 51A and 51B instead of holding members 51 and 52 (FIG. 1). Casing 300A includes a main body 310A and lid bodies 320 and 330. Main body 310A is a hollow housing provided with openings in opposing end surfaces (the end surface on the +X side and the end surface on the −X side) in the X direction, and cell connected bodies 10 and 20 are accommodated therein. Lid body 320 shown in FIG. 7 is the same as lid body 320 shown in FIG. 1 and closes the opening on the +X side in main body 310A. Lid body 320 is provided with sealing hole 321. Lid body 330 closes the opening on the −X side in main body 310A. Lid body 330 is provided with a sealing hole 331. Each of sealing holes 321 and 331 has a sealing structure, for example, with a metallic cap (outside of the casing) and a sealing member (inside of the casing). While such a sealing structure ensures hermeticity in casing 300A, gas is emitted to the outside of casing 300A through sealing holes 321 and 331 when the pressure in casing 300A exceeds a prescribed level.

As shown in FIGS. 7 to 9, holding members 51A and 52A are obtained by providing flow paths GL1 and GL2 in holding members 51 and 52 (see FIG. 1), respectively. Each of flow paths GL1 and GL2 is a flow path through which gas generated from the power storage cell is emitted. Specifically, projections P14A and P24A shown in FIG. 9 are obtained by providing through holes (for example, holes passing through in the Z direction) that allow communication of a space between two power storage cells adjacent in the X direction with flow paths GL1 and GL2 in projections P14 and P24 (see FIG. 6), respectively. Each of the through hole and flow paths GL1 and GL2 guides gas generated from each power storage cell included in cell connected bodies 10 and 20 accommodated in casing 300A to sealing hole 321 or 331. Each of sealing holes 321 and 331 is constructed to emit gas in casing 300A to the outside of casing 300A. According to such a construction, gas generated from the power storage cell is more readily appropriately emitted.

Flow paths GL1 and GL2 define cavities in the inside of holding members 51A and 52A, respectively. Each of holding members 51A and 52A thus has a hollow structure. Impact externally applied to casing 300A is thus more readily absorbed by holding members 51A and 52A. Each of flow paths GL1 and GL2 may be provided by mechanical working or provided chemically by etching or the like. The flow path may be provided in only one of holding members 51 and 52 shown in FIG. 1.

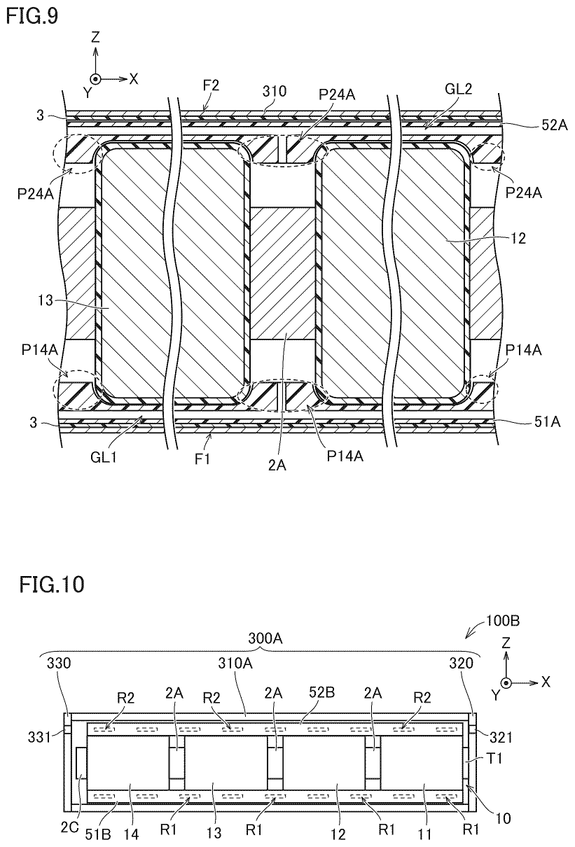

FIG. 10 is a diagram showing a second modification of the battery shown in FIG. 1. As shown in FIG. 10, a battery 100B according to the second modification is basically similar in construction to battery 100A shown in FIG. 7. Battery 100B includes holding members 51B and 52B instead of holding members 51A and 52A (FIG. 7). Holding members 51B and 52B are obtained by providing cavities R1 and R2 that do not function as gas emission flow paths in holding members 51 and 52 (see FIG. 1), respectively. In holding member 51B, a plurality of cavities R1 are provided. In holding member 52B, a plurality of cavities R2 are provided. Each of holding members 51B and 52B thus has a hollow structure. Impact externally applied to casing 300A is thus more readily absorbed by holding members 51B and 52B. Each of cavities R1 and R2 may be a cavity in a porous body. The cavity may be provided in only one of holding members 51 and 52 shown in FIG. 1.

FIG. 11 is a diagram showing a third modification of the battery shown in FIG. 1. As shown in FIG. 11, a battery 100C according to the third modification is constructed such that holding member 52A (FIG. 7) has been removed from battery 100A shown in FIG. 7. In battery 100C, a space (a region R3) between the second surface of each power storage cell included in cell connected bodies 10 and 20 and the inner surface (top surface) of casing 300A functions as the gas emission flow path (the flow path through which gas generated from each power storage cell is guided to sealing hole 321 or 331).

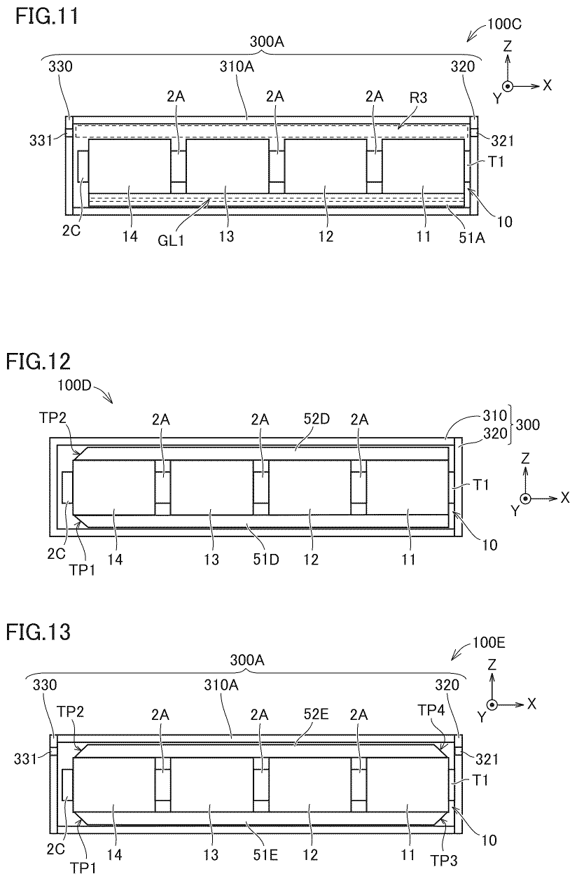

FIG. 12 is a diagram showing a fourth modification of the battery shown in FIG. 1. As shown in FIG. 12, a battery 100D according to the fourth modification is basically similar in construction to battery 100 shown in FIG. 1. Battery 100D includes holding members 51D and 52D instead of holding members 51 and 52 (FIG. 1). Tapered surfaces TP1 and TP2 are formed at ends on the −X side of holding members 51D and 52D, respectively. Each of tapered surfaces TP1 and TP2 is a sloped surface decreasing in dimension in the Z direction toward the end (the −X side). As the tapered surface is formed at the end of each of holding members 51D and 52D, cell connected bodies 10 and 20 to which holding members 51D and 52D are attached are more readily inserted from the end on the −X side into main body 310 of casing 300.

FIG. 13 is a diagram showing a fifth modification of the battery shown in FIG. 1. As shown in FIG. 13, a battery 100E according to the fifth modification is basically similar in construction to battery 100A shown in FIG. 7. Battery 100E includes holding members 51E and 52E instead of holding members 51A and 52A (FIG. 7). Tapered surfaces TP1 and TP2 are formed at ends on the −X side of holding members 51E and 52E, respectively. Each of tapered surfaces TP1 and TP2 is a sloped surface decreasing in dimension in the Z direction toward a first end (the −X side). Tapered surfaces TP3 and TP4 are formed at ends on the +X side of holding members 51E and 52E, respectively. Each of tapered surfaces TP3 and TP4 is a sloped surface decreasing in dimension in the Z direction toward a second end (the +X side). As the tapered surface is formed at each of the opposing ends of each of holding members 51E and 52E, cell connected bodies 10 and 20 to which holding members 51E and 52E are attached are more readily inserted in main body 310A of casing 300A.

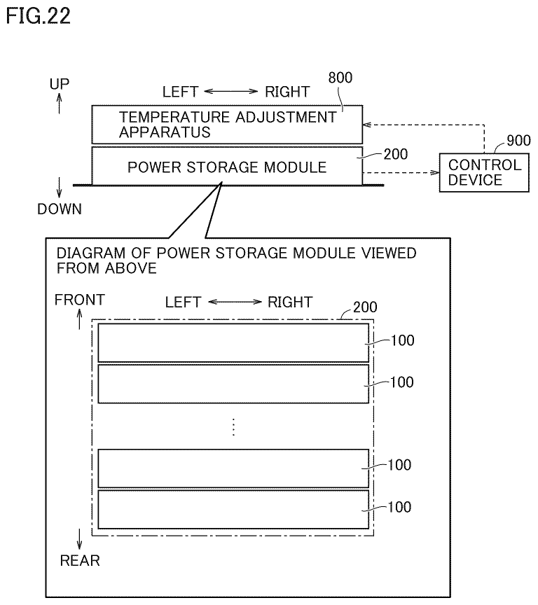

FIG. 14 is a diagram showing a sixth modification of the battery shown in FIG. 1. As shown in FIG. 14, a battery 100F according to the sixth modification is the same in cross-sectional structure as battery 100 shown in FIG. 5. Battery 100F includes a holding member 52F instead of holding member 52 (FIG. 5). Holding member 52F is higher in thermal conductivity than holding member 51. Specifically, holding member 52F contains metal and holding member 51 contains resin. Holding member 52F may be formed of metal in its entirety. Holding member 51 may be formed of resin in its entirety. Holding member 52F is provided with projections P21F, P22F, and P23F similar in shape to projections P21, P22, and P23 shown in FIG. 5, respectively. Though not shown in FIG. 14, holding member 52F further includes a projection corresponding to projection P24 shown in FIG. 6. In battery 100F, thermal conductivity of holding member 52F located on the +Z side of each power storage cell is high. Therefore, each power storage cell is more readily heated or cooled from the outside (for example, a temperature adjustment apparatus 800 shown in FIG. 22 which will be described later) on the +Z side of each power storage cell.

In battery 100F, holding member 52F contains metal so that holding member 52F is high in thermal conductivity. Holding member 51 containing resin, on the other hand, is excellent in toughness and formability, and hence it readily holds each power storage cell included in cell connected bodies 10 and 20. Holding member 52F may include a main body portion formed of metal and a projection (each projection described above) formed of resin. Holding member 52F may have a structure in which particulate metal (for example, a metallic filler) is dispersed in a binder (for example, a resin binder).

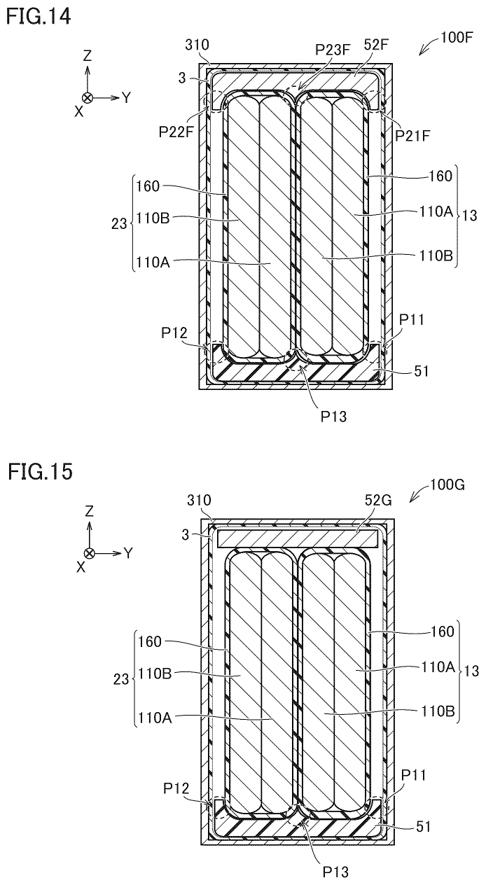

FIG. 15 is a diagram showing a seventh modification of the battery shown in FIG. 1. As shown in FIG. 15, a battery 100G according to the seventh modification is basically the same in cross-sectional structure as battery 100F shown in FIG. 14. Battery 100G includes a holding member 52G instead of holding member 52F (FIG. 14). Holding member 52G is constructed such that each projection described previously has been removed from holding member 52F. Holding member 52G is a plate-shaped member made of metal (a main body portion in a shape of a flat plate formed of metal) and higher in thermal conductivity than holding member 51 made of resin. According to such a structure, each power storage cell is more readily heated or cooled from the outside (for example, temperature adjustment apparatus 800 shown in FIG. 22 which will be described later) on the +Z side of each power storage cell. Holding member 52G may have a structure in which particulate metal (for example, a metallic filler) is dispersed in a binder (for example, a resin binder).

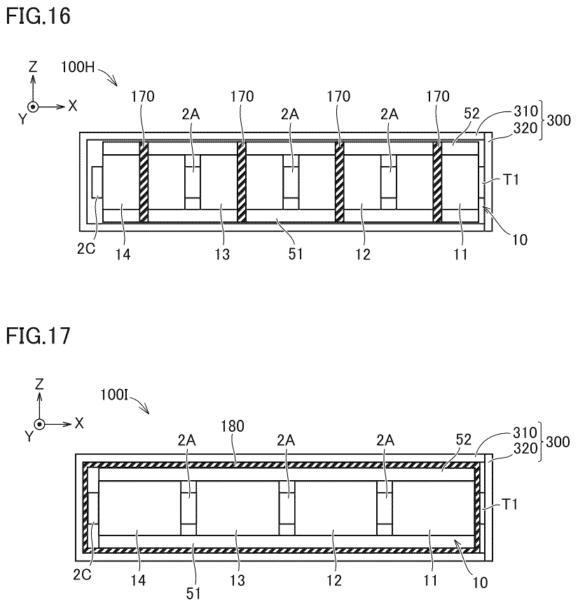

FIG. 16 is a diagram showing an eighth modification of the battery shown in FIG. 1. As shown in FIG. 16, a battery 100H according to the eighth modification is basically similar in construction to battery 100 shown in FIG. 1. In battery 100H, cell connected bodies 10 and 20 and holding members 51 and 52 are integrated by being wound by a member 170 in a form of a band. Member 170 is wound around each power storage cell and holding members 51 and 52 located on opposing sides thereof, for example, with the X axis being defined as a rotation axis. Position displacement of cell connected bodies 10 and 20 and holding members 51 and 52 is thus less likely. In addition, cell connected bodies 10 and 20 to which holding members 51 and 52 are attached are more readily inserted in main body 310 of casing 300.

Member 170 may be a tape which is adhesive on opposing surfaces or on one surface thereof. In order to improve recyclability, a tape that can be peeled off with a specific organic solvent may be adopted as member 170. Member 170 is not limited to the tape in the form of the band. Member 170 may be formed in a form of a line like a string. A resin member, a heat shrinkable member, an elastic body (for example, a rubber band), or the like can also be adopted as member 170.

FIG. 17 is a diagram showing a ninth modification of the battery shown in FIG. 1. As shown in FIG. 17, a battery 100I according to the ninth modification is basically similar in construction to battery 100 shown in FIG. 1. In battery 100I, cell connected bodies 10 and 20 and holding members 51 and 52 are integrated by being wound by a member 180 in a form of a sheet. Member 180 is wound around the entirety of cell connected bodies 10 and 20 and holding members 51 and 52, for example, with the Y axis being defined as the rotation axis. Position displacement of cell connected bodies 10 and 20 and holding members 51 and 52 is thus less likely. In addition, cell connected bodies 10 and 20 to which holding members 51 and 52 are attached are more readily inserted in main body 310 of casing 300. Member 180 may be a resin film (for example, a film containing vinyl chloride resin, polyvinylidene chloride, polyethylene, or polyolefin). Member 180 may be a heat shrinkable sheet.

FIG. 18 is a diagram showing a tenth modification of the battery shown in FIG. 1. As shown in FIG. 18, a battery 100J according to the tenth modification is basically the same in cross-sectional structure as battery 100 shown in FIG. 5. In battery 100J, a gap is provided between the power storage cell (for example, power storage cell 13) of cell connected body 10 and the power storage cell (for example, power storage cell 23) of cell connected body 20 adjacent in the Y direction, and holding members 51J and 52J include projections P13J and P23J formed to enter the gap, instead of projections P13 and P23 (FIG. 1), respectively. Each of projections P13J and P23J has a dimension (a dimension in the Y direction) corresponding to an interval between the power storage cells and functions as a spacer. Each of projections P13J and P23J restricts movement of power storage cell 13 toward the −Y side and movement of power storage cell 23 toward the +Y side and suppresses power storage cells 13 and 23 coming too close to each other as shown, for example, in FIG. 18.

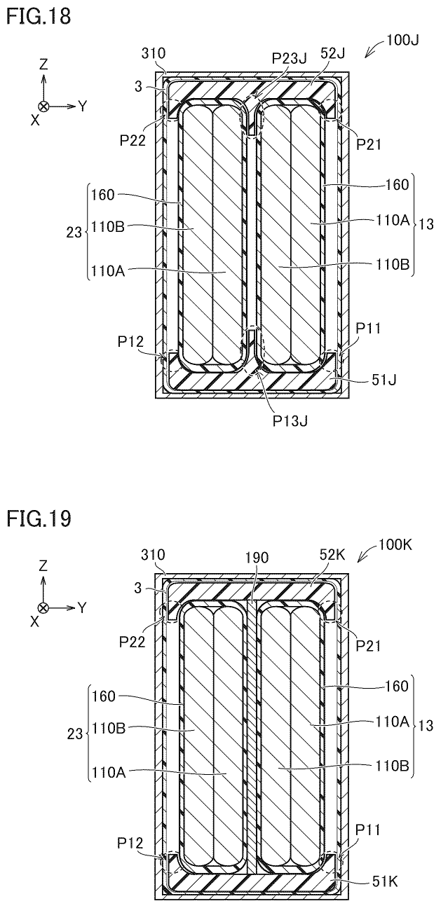

FIG. 19 is a diagram showing an eleventh modification of the battery shown in FIG. 1. As shown in FIG. 19, a battery 100K according to the eleventh modification is basically the same in cross-sectional structure as battery 100J shown in FIG. 18. In battery 100K, each of holding members 51K and 52K does not include a projection (projections P13J and P23J shown in FIG. 18) introduced in between the power storage cell (for example, power storage cell 13) of cell connected body 10 and the power storage cell (for example, power storage cell 23) of cell connected body 20 adjacent in the Y direction, but a metallic plate 190 is provided as being introduced in between the power storage cells instead of the projection. An end on the −Z side of metallic plate 190 is in contact with holding member 51K and an end on the +Z side of metallic plate 190 is in contact with holding member 52K. Metallic plate 190 is, for example, an aluminum plate. Without being limited as such, metallic plate 190 may be formed of metal other than aluminum. For example, metallic plate 190 may be, for example, a copper plate or a stainless steel plate.

According to the construction, for example, heat from each power storage cell is readily radiated to the outside of casing 300 through metallic plate 190. In heating each power storage cell from the outside (for example, temperature adjustment apparatus 800 shown in FIG. 22 which will be described later) of casing 300, heat more readily conducts to each power storage cell through metallic plate 190. In a form where sufficient thermal conductivity is secured, at least one end in the Z direction of metallic plate 190 does not have to be in contact with the holding member.

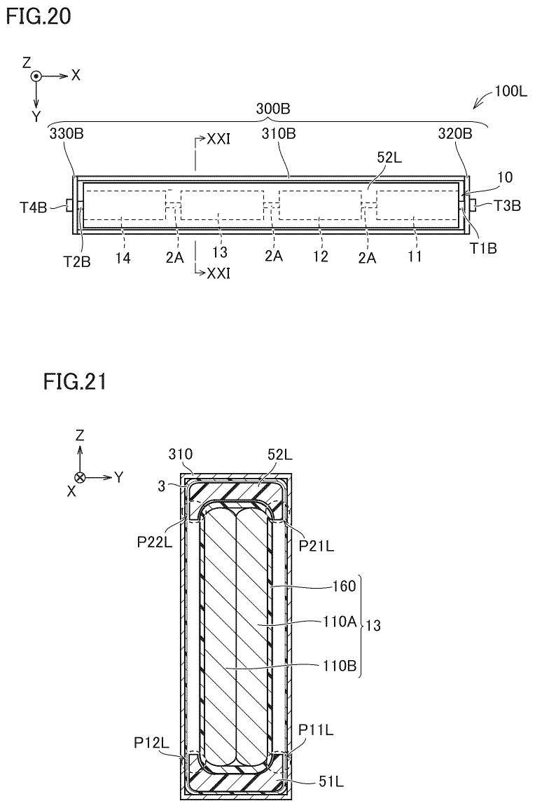

It is not essential that a plurality of cell connected bodies are accommodated in the casing, and a single cell connected body may be accommodated in the casing. FIG. 20 is a diagram showing a twelfth modification of the battery shown in FIG. 1. FIG. 21 is a cross-sectional view along the line XXI-XXI in FIG. 20.

As shown in FIG. 20, a battery 100L according to the twelfth modification includes a casing 300B and cell connected body 10 accommodated in casing 300B. Cell connected body 10 is accommodated in casing 300B but cell connected body 20 is not accommodated in casing 300B. Casing 300B includes a main body 310B and lid bodies 320B and 330B. Main body 310B is a hollow housing provided with openings in opposing end surfaces in the X direction (the end surface on the +X side and the end surface on the −X side), and one cell connected body (cell connected body 10) is accommodated in main body 310B. Lid body 320B closes the opening on the +X side in main body 310B. Lid body 330B closes the opening on the −X side in main body 310B. Lid bodies 320B and 330B are provided with electrode tabs T3B and T4B, respectively. A connection terminal T1B is provided in power storage cell 11 located at one end (+X side) in the X direction of cell connected body 10, and a connection terminal T2B is provided in power storage cell 14 located at the other end (−X side) in the X direction of cell connected body 10. Electrode tabs T3B and T4B are electrically connected to respective connection terminals T1B and T2B. Electrode tabs T3B and T4B function, for example, as the negative electrode tab and the positive electrode tab, respectively. Without being limited as such, with polarity being reversed, electrode tab T4B may serve as the negative electrode tab and electrode tab T3B may serve as the positive electrode tab.

As shown in FIG. 21, a holding member 51L is basically formed in the shape of the plate. Holding member 51L includes projections P11L and P12L (first projections) that project from the main body portion in the shape of the plate (first main body portion) toward cell connected body 10, in addition to that main body portion. Each of projections P11L and P12L projects toward cell connected body 10 (+Z side). A holding member 52L is basically formed also in the shape of the plate. Holding member 52L includes projections P21L and P22L (second projections) that project from the main body portion in the shape of the plate (second main body portion) toward cell connected body 10, in addition to that main body portion. Each of projections P21L and P22L projects toward cell connected body 10 (−Z side). Each of holding members 51L and 52L contains an insulating material (for example, resin) and it is insulating. Holding members 51L and 52L hold each power storage cell (including power storage cell 13 shown in FIG. 21) included in cell connected body 10 to maintain the same at a prescribed position. Specifically, projections P11L and P12L are located at ends (corner portions) in the Y direction on the first surface of the power storage cell and function as tab portions. Position displacement of the power storage cell is thus suppressed. Projections P21L and P22L are located at ends (corner portions) in the Y direction on the second surface of the power storage cell and function as tab portions. Position displacement of the power storage cell is thus suppressed.

It is not essential that all power storage cells included in the cell connected body are held by the holding members. For example, only power storage cells 12 and 13 among power storage cells 11 to 14 included in cell connected body 10, that is, only a central portion in the X direction of cell connected body 10, may be held by the holding members. Only power storage cells 11 and 14 among power storage cells 11 to 14 included in cell connected body 10, that is, only opposing ends in the X direction of cell connected body 10, may be held by the holding members. The casing in the shape of the parallelepiped where the cell connected body is accommodated may be assembled by joining (for example, welding with laser) six plates that form six separately formed surfaces (surfaces F1 to F6) to one another.

Batteries 100 and 100A to 100L and a modified form thereof described previously alone can function as the power storage device. A plurality of such batteries may be combined into a module.

FIG. 22 is a diagram showing an exemplary power storage module including a plurality of batteries. FIG. 22 shows an upward-downward direction, a forward-rearward direction, and a left-right direction orthogonal to one another. “Down” corresponds to a vertical direction (a direction of gravity) and “up” refers to a direction opposite thereto. A figure showing the power storage module viewed from above shows an internal structure of a power storage module 200.

Power storage module 200 shown in FIG. 22 includes a plurality of batteries 100. In power storage module 200, the plurality of batteries 100 (see FIG. 1) are arranged such that a surface on the +Z side of each battery faces up and a surface on the −Z side of each battery faces down. For each of the plurality of batteries 100, which of the left and the right lid body 320 (the surface on the +X side) shown in FIGS. 1 and 2 should face can freely be set. For example, orientations of all batteries 100 may be aligned in power storage module 200. Alternatively, power storage module 200 may include both of battery 100 lid body 320 of which faces the right and battery 100 lid body 320 of which faces the left. The plurality of batteries 100 may be connected electrically in series or in parallel. Power storage module 200 functions as the power storage device.

In the example shown in FIG. 22, temperature adjustment apparatus 800 is provided on an upper surface of power storage module 200. Temperature adjustment apparatus 800 is configured to adjust a temperature of each of the plurality of batteries 100 included in power storage module 200. Temperature adjustment apparatus 800 may include at least one of a heater and a cooler. Temperature adjustment apparatus 800 is controlled by a control device 900. Control device 900 includes, for example, a processor and a storage device, and it is connected through a signal line to connector 323 (FIG. 1) of each of the plurality of batteries 100 included in power storage module 200. Control device 900 receives a signal (for example, a sensor detection value) from connector 323 of each battery and sends a control command to temperature adjustment apparatus 800. Control device 900 may control temperature adjustment apparatus 800 based on a state of each battery. In power storage module 200, another battery (any of batteries 100A to 100L or a battery obtained by making various modifications described previously to the construction thereof) may be adopted instead of battery 100. Temperature adjustment apparatus 800 may be provided on a lower surface of power storage module 200.

Batteries 100 and 100A to 100L and the modified form thereof described previously and power storage module 200 may be mounted, for example, on a mobile body. Examples of the mobile body include a car (a battery electric vehicle, a hybrid electric vehicle, or the like), a vehicle other than the car (a ship, an airplane, or the like), a mobile machine (an agricultural machine, a construction machine, or the like), and an unmanned mobile body (an automated guided vehicle, a robot, or the like). Any application of the power storage device may be appliable, and the power storage device may be for a stationary use.

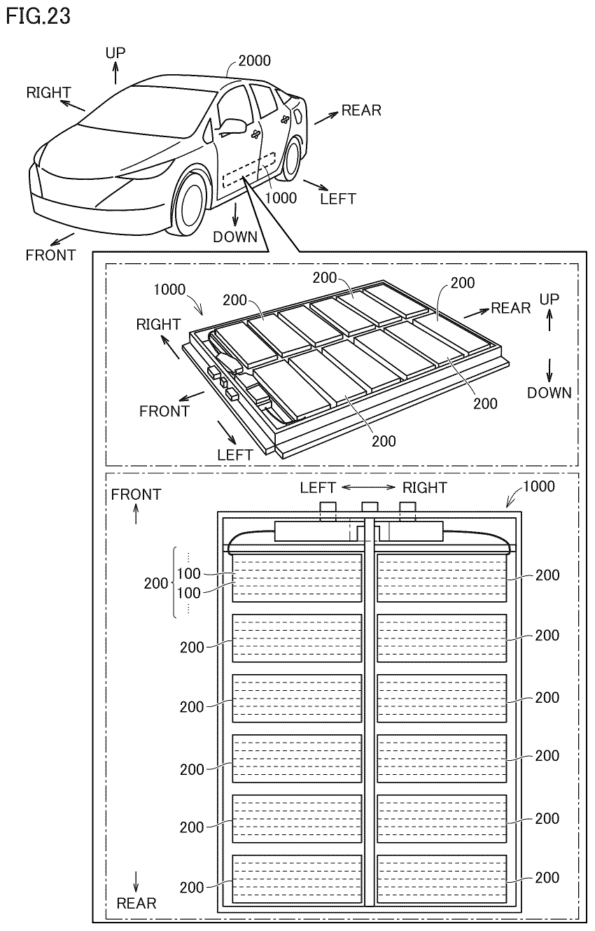

FIG. 23 is a diagram showing an exemplary vehicle on which the power storage module shown in FIG. 22 is mounted. A vehicle 2000 shown in FIG. 23 includes a battery pack 1000. Battery pack 1000 includes a plurality of power storage modules 200 and functions as the power storage device. Battery pack 1000 may further include temperature adjustment apparatus 800 shown in FIG. 22. Battery pack 1000 may be placed on or below a floor of vehicle 2000. Vehicle 2000 is a battery electric vehicle configured to travel with electric power outputted, for example, from battery pack 1000. Battery pack 1000 may supply electric power to a travel motor mounted on vehicle 2000. In battery pack 1000, power storage modules 200 are electrically connected to one another, for example, through a bus bar. Battery pack 1000 may include at least one hundred power storage cells.

Various characteristics (characteristics described in the embodiment and the modifications) in connection with the power storage devices described above may freely be combined and carried out. The power storage device may be applied to an apparatus other than the vehicle.

Though an embodiment of the present disclosure has been described, it should be understood that the embodiment disclosed herein is illustrative and non-restrictive in every respect. The scope of the present disclosure is defined by the terms of the claims and is intended to include any modifications within the scope and meaning equivalent to the terms of the claims.

What is claimed is:

1. A power storage device comprising:
a casing;
one or more cell connected bodies accommodated in the casing, each of the one or more cell connected bodies including a plurality of power storage cells and a connection portion that electrically connects the power storage cells to each other; and
one or more holding members that hold at least one of the plurality of power storage cells, between an inner surface of the casing and at least one of the one or more cell connected bodies.

2. The power storage device according to claim 1, wherein
the one or more holding members include, for at least one cell connected body of the one or more cell connected bodies, a first holding member that holds a first surface of each of two or more power storage cells included in the cell connected body.

3. The power storage device according to claim 2, wherein
the first holding member includes a first main body portion in a shape of a plate and one or more first projections that project from the first main body portion toward the one or more cell connected bodies.

4. The power storage device according to claim 2, wherein
the one or more holding members further include, for at least one cell connected body of the one or more cell connected bodies, a second holding member that holds a second surface opposite to the first surface of each of the two or more power storage cells included in the cell connected body.

5. The power storage device according to claim 4, wherein
the second holding member includes a second main body portion in a shape of a plate and one or more second projections that project from the second main body portion toward the one or more cell connected bodies.

6. The power storage device according to claim 4, wherein
a flow path is provided in at least one of the first holding member and the second holding member, the flow path being configured to discharge gas generated from at least one of the plurality of power storage cells.

7. The power storage device according to claim 4, wherein
at least one of the first holding member and the second holding member has a hollow structure.

8. The power storage device according to claim 4, wherein
the second holding member is higher in thermal conductivity than the first holding member.

9. The power storage device according to claim 8, wherein
the second holding member contains metal and the first holding member contains resin.

10. The power storage device according to claim 4, wherein
a tapered surface is formed at an end of each of the first holding member and the second holding member.

11. The power storage device according to claim 4, wherein
the one or more cell connected bodies, the first holding member, and the second holding member are integrated by winding a member in a form of a line, a band, or a sheet.

12. The power storage device according to claim 1, wherein
the casing has a geometry in a shape of a parallelepiped,
the casing is provided with four surfaces that extend in a connection direction of each of the one or more cell connected bodies and two surfaces that cover ends of the one or more cell connected bodies,
the four surfaces include first opposing surfaces which are a pair of surfaces opposed to each other and second opposing surfaces which are opposing surfaces larger in area than the first opposing surfaces, and
the holding members are arranged on the first opposing surfaces.

13. A vehicle comprising the power storage device according to claim 1.
